(19) United States
(12) Patent Application Publication
(10) Pub. No.: US 2026/0213626 A1
(43) Pub. Date: Jul. 23, 2026

(54) Q-CLIP THERMISTOR WIRE CLIP

(71) Applicant: BorgWarner Inc., Auburn Hills, MI (US)

(72) Inventors: Steve C. Burton, Anderson, IN (US); Kristopher Graves, Fishers, IN (US)

(21) Appl. No.: 19/447,618

(22) Filed: Jan. 13, 2026

Related U.S. Application Data
(60) Provisional application No. 63/746,650, filed on Jan. 17, 2025.

(51) Int. Cl. H02K 11/25; G01K 1/14; G01K 7/22

(52) U.S. Cl. CPC H02K 11/25; G01K 1/14; G01K 7/22

(57) ABSTRACT

A support for a conductor in an electric machine, including a body receivable in a stator of the electric machine between adjacent coils, the body defining an axis, a conductor anchor extending from the body at an angle to the axis, the conductor anchor having at least two conductor contact points, the angle of the anchor causing bending of the conductor at at least two contact points when the conductor is disposed in the anchor and the body is disposed in the stator. A stator having a coil thereon, a conductor separate from the coil, and a support disposed in the stator and in supportive contact with the conductor. A method for supporting a conductor at a stator of an electric machine, including disposing the support in contact with the conductor, rotating the support to introduce plastic deformations in the conductor, and inserting the body into the stator.

### CROSS REFERENCE TO RELATED APPLICATIONS

This application claims the benefit of an earlier filing date from U.S. Provisional Application Serial No. 63/746,650 filed January 17, 2025, the entire disclosure of which is incorporated herein by reference.

### BACKGROUND OF THE INVENTION

Sensors are often employed to monitor temperatures in various portions of an electric machine. In some cases it is desirable to include a thermal sensor on a stator of the electric machine and particularly in connection with an electric motor for a motor vehicle. When mounting the sensor to the stator, conductor(s) of the sensor must be managed and may be held in place by a harness or could be secured to the stator with heat shrink tubing. In some stator applications, the sensor conductors may be laced into coils of the stator. When in place, the sensor and or conductors may be covered with varnish. Current techniques for mounting a sensor and/or sensor conductors to a stator are labor intensive and often result in an inadequate bond, inconsistent placement, and inadequate sensing such as if the sensor or its conductor(s) become loose before varnish application. Accordingly, the industry would welcome new techniques for managing conductors for a sensor attached to a stator.

### SUMMARY

An embodiment of a support for a conductor in an electric machine, including a body configured and dimensioned to be receivable in a stator of the electric machine between adjacent coils, the body defining an axis, a conductor anchor extending from the body at an angle to the axis, the conductor anchor having at least two conductor contact points, the angle of the anchor causing bending of the conductor at at least two of the at least two contact points when the conductor is disposed in the anchor and the body is disposed in the stator.

An embodiment of a stator including a stator having a coil thereon, a conductor separate from the coil, and a support disposed in the stator and in supportive contact with the conductor.

An embodiment of a method for supporting a conductor at a stator of an electric machine, including disposing the support in contact with the conductor, rotating the support to introduce plastic deformations in the conductor, and inserting the body into the stator.

### BRIEF DESCRIPTION OF THE DRAWINGS

The following descriptions should not be considered limiting in any way. With reference to the accompanying drawings, like elements are numbered alike:

FIG. 1 is a perspective view of a support as disclosed herein disposed in a stator of an electric machine;

FIG. 2 is a side perspective view of the same structure as FIG. 1;

FIG. 3 is a perspective view of the support alone;

FIG. 3A illustrated a variation of FIG. 3 where the anchor is perimetrically open as opposed to the variation of FIG. 3 where the anchor is perimetrically closed;

FIG. 4 is a side view of the support alone;

FIG. 4A is a partial sectional view taken along section lines 4A-4A of FIG. 3;

FIG. 5 is a plan view of the support disposed in the intercoil space of the stator;

FIG. 6 is a partial illustration of the support illustrating a convex drive feature; and

FIG. 7 is a partial illustration of the support illustrating a concave drive feature.

### DETAILED DESCRIPTION

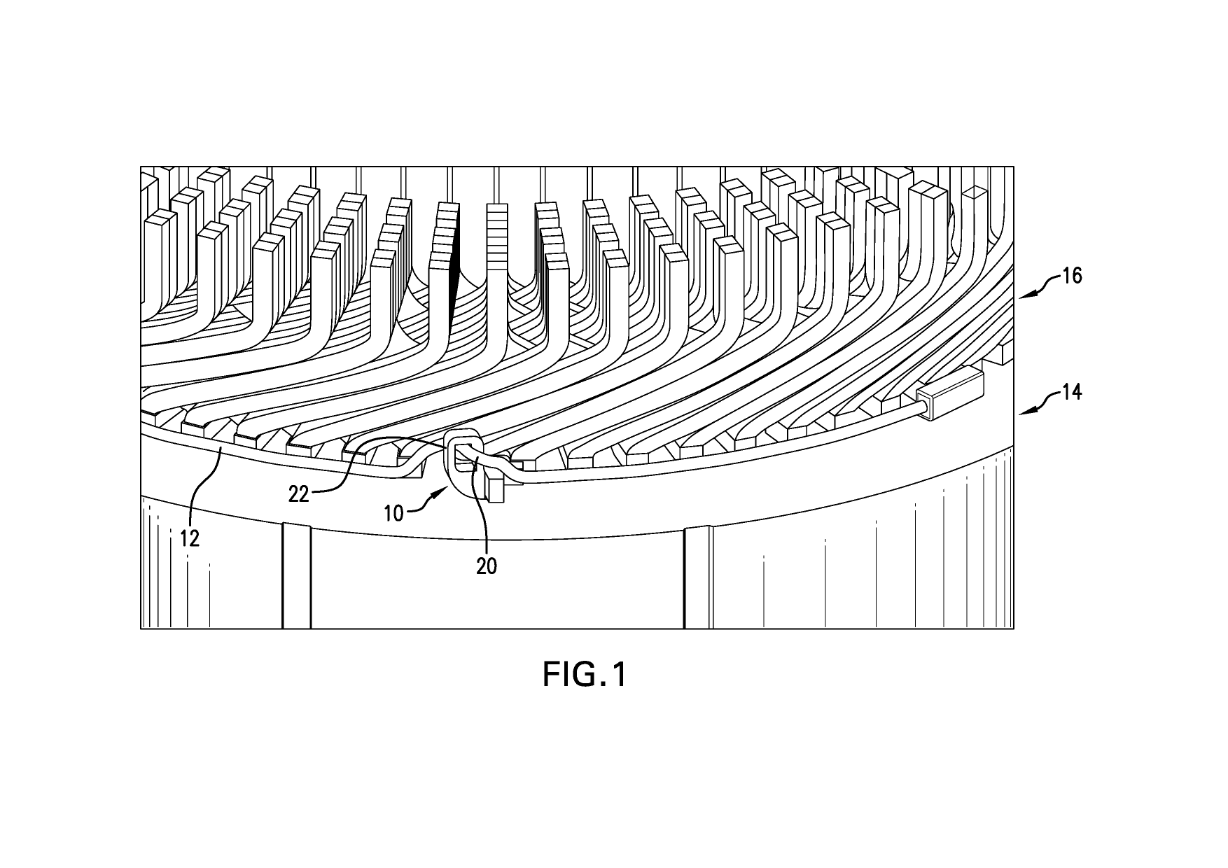

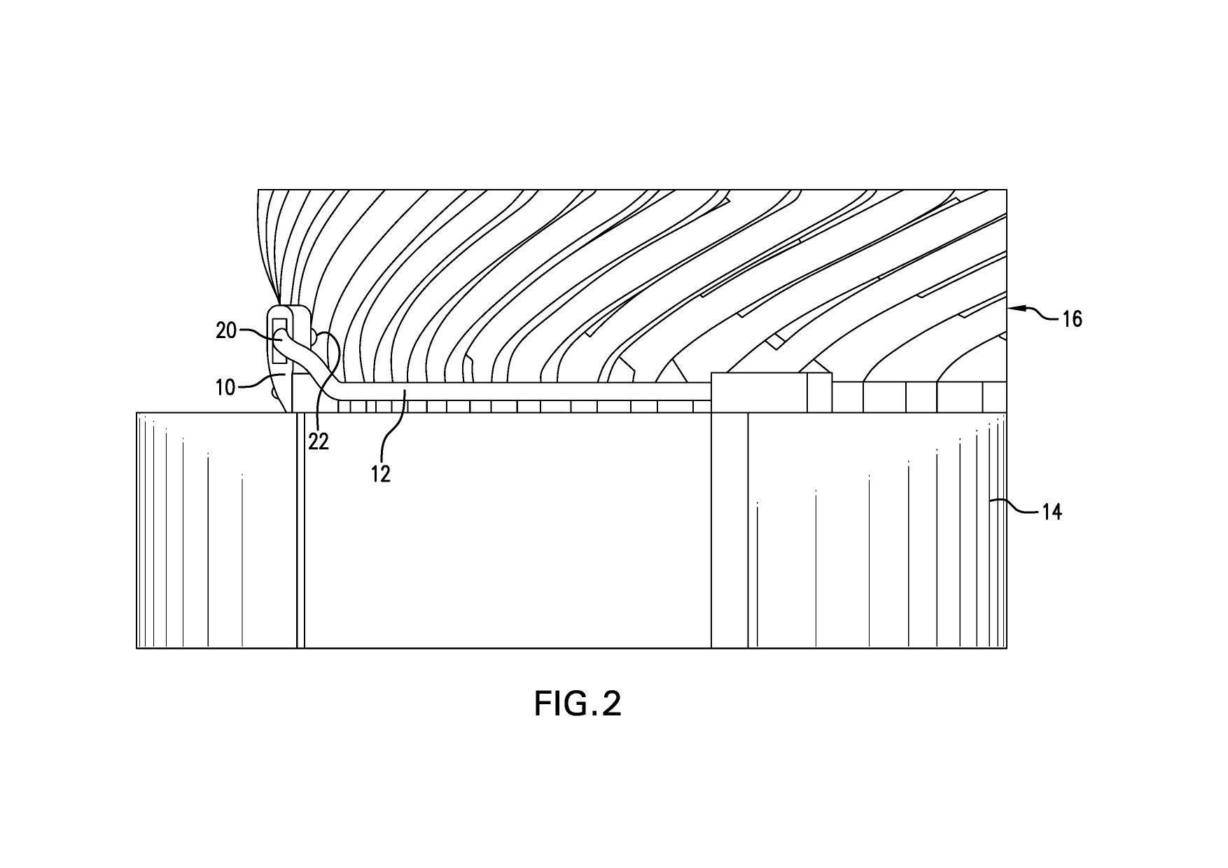

Referring to FIGS. 1 and 2, a support 10 for a conductor 12 in an electric machine 14 is illustrated disposed upon a stator 16 of the electric machine 14. The conductor may be related to a sensor of the electric machine, such as a thermal sensor that may be a thermistor, but the support 10 is not limited to supporting a conductor associated with such a sensor but could be used to support other conductors also. The support 10 functions to both anchor and tension the conductor 12 to ensure that there will be no movement of the conductor 12, including sagging of the conductor 12, after insertion of the support 10 in the stator 16. Tension is maintained on conductor 12 by ensuring that at least two plastic deformations 20 and 22 are created in the conductor 12 during rotating of the support 10 into position to insert in the stator 16. The plastic deformations 20 and 22 create a physical engagement with the support 10. Anchoring then uses both friction and a bending moment to prevent movement of the conductor 12 after insertion. Normal operation of the electric machine does not create enough tensile load on the conductor to overcome both friction and the bending moment required to move the conductor 12 after inducing the plastic deformations 20 and 22 in the conductor 12. The support 10 may be constructed of any material having sufficient structural properties to hold the conductor 12 as described herein though nonconducting material may provide an advantage to avoid loss of field strength.

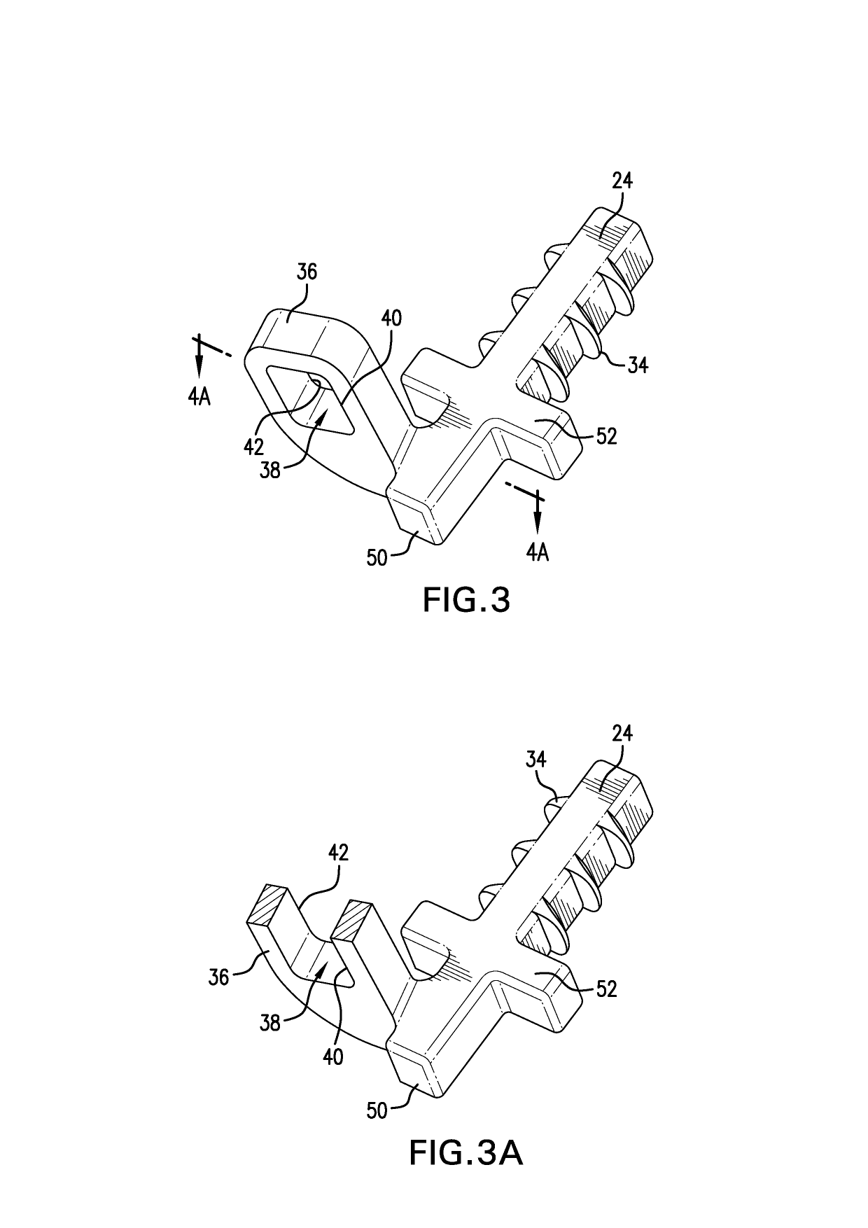

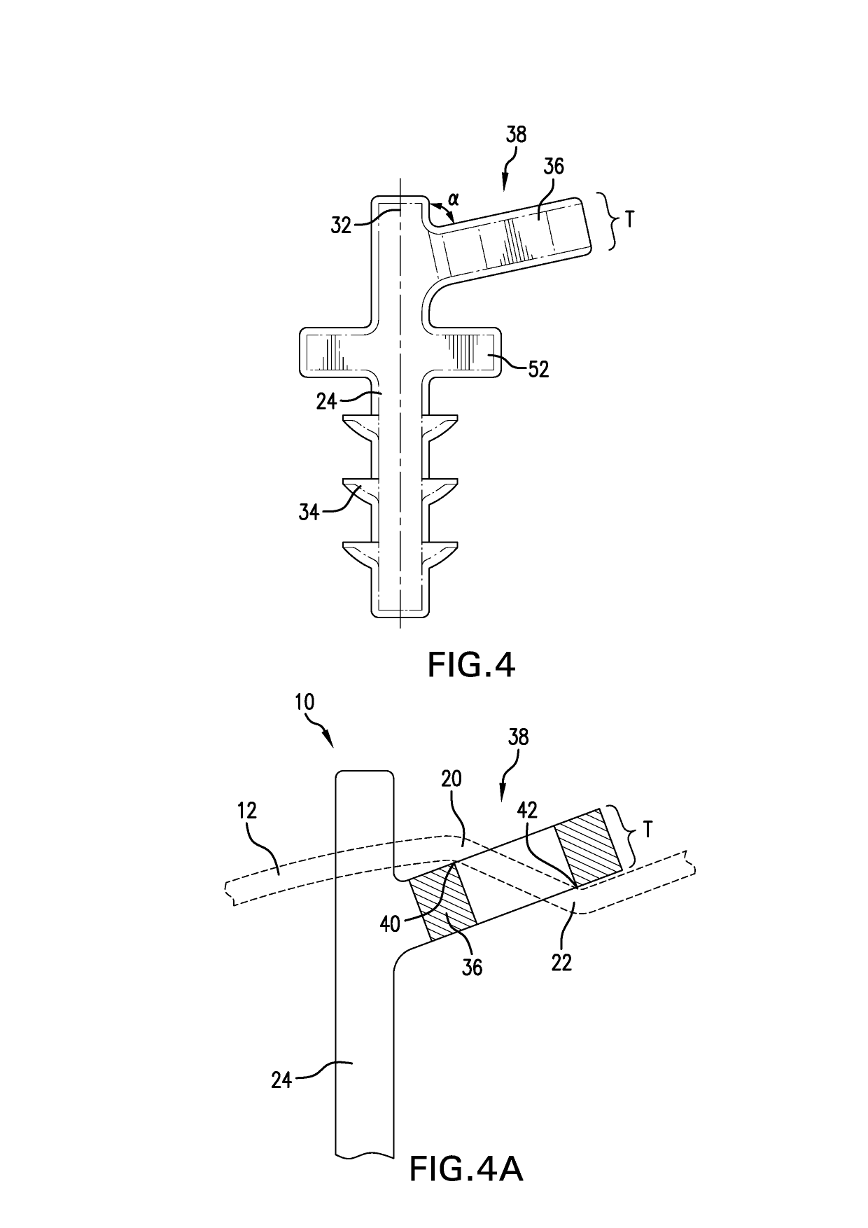

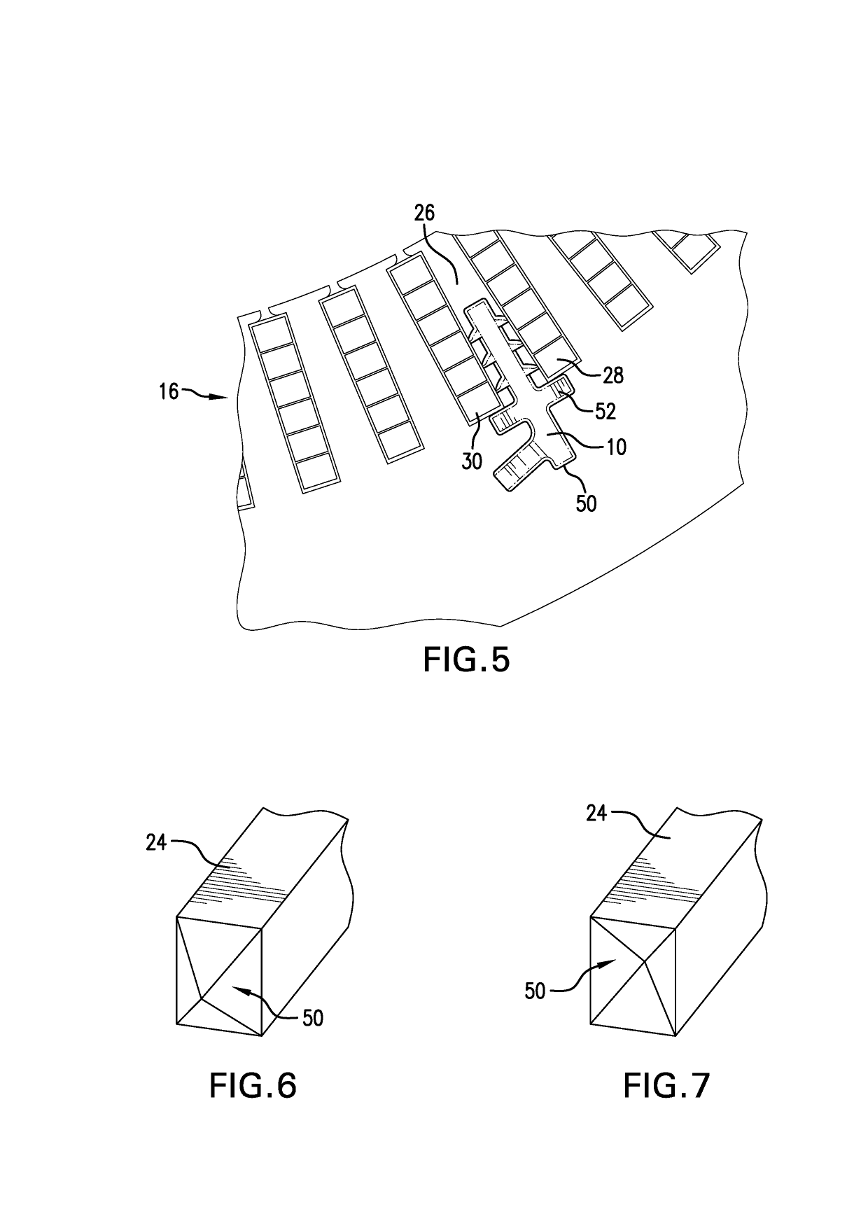

Referring to FIGS. 3 and 4, the support 10 is illustrated by itself in perspective and plan views, respectively, to provide a better understanding of the structure of the support 10. It will be appreciated that the support 10 includes a body 24 configured and dimensioned to be receivable in an intercoil space 26 (see FIG. 5) of stator 16 of the electric machine 14 between adjacent coils 28 and 30. The body defines an axis 32 along its length whose direction is relevant to other features discussed below. In some embodiments, the body 24 is configured with one or more barbs 34 configured to facilitate insertion of the body into the intercoil space 26 while at the same time increasing resistance to the body 24 being removed from the intercoil space 26.

Extending from the body 24 is a conductor anchor 36. Anchor 36 is disposed at an angle α (identified in FIG. 4) to the axis 32, The angle α ranges from about 45 degrees to about 135 degrees. In an embodiment the angle α ranges from about 80 degrees to about 105 degrees. In any case, the angle α is one component of the anchor function while the other is thickness of the anchor 36. If the thickness T of the anchor 36 is greater, the angle α can be smaller while still achieving the plastic deformations 20 and 22. Ultimately, it is required that the conductor 12 is plastically deformed (plastic deformations 20 and 22) at at least two points of contact with the anchor 36. In an embodiment, the plastic deformations 20 and 22 are in opposing directions to one another. To achieve this condition, the anchor 36 is configured to present an opening 38, whether perimetrically closed (FIG. 3) or perimetrically open (FIG. 3A) for the conductor 12 to pass through the anchor 36. The conductor will slide through this opening 38 when the body 24 is not oriented to be inserted into the stator 16 but upon reorienting the body 24 to be inserted into the stator 16, the conductor 12 will make contact with the anchor 36 at at least two points 40 and 42 of the anchor 36 (see FIGS. 1, 2, and 4A for clarity) where the conductor 12 will be forced to plastically deform (deformations 20 and 22). It should be appreciated that when the support 10 is oriented in space such that the body 24 is oriented for insertion into the stator 16, the conductor 12 will not be able to extend in a straight line through the anchor 36. Rather the conductor 12 is forced to assume a zig zag appearance, hence the plastic deformations 20 and 22. FIG. 4A also illustrates the thickness T issue noted above. The thicker T is, the greater the conductor 12 must bend at point 40 to follow its own path through the opening 38 and contact point 42 and then back to its arc along the outside surface of the stator 16. Shallower angles α can be made to cause the plastic deformations 20 and 22 with a thicker T. It should also be evident from FIGS. 3, 4, and 4A that should the opening 38 be aligned with the conductor 12, it may be easily slipped along the conductor 12 facilitating desired positioning. Then when the support 10 is rotated to align the body 24 with the intercoil space 26, the conductor will be forced into the position shown in FIG. 4A where contact with points 40 and 42 will cause plastic deformations 20 and 22, thereby causing the conductor 12 to be restrained at the anchor 36.

In addition to the structure of support 10 that induces plastic deformation of the conductor 12, there is an additional feature of the support 10. Referring to FIGS. 3 and 4, support 10 includes a drive feature 50. In some embodiments, the drive feature is a surface that is orthogonal to the axis 32 as illustrated. In other embodiments, the drive feature 50 could be oblige to the axis 32 in a range of about 20 degrees off orthogonal in any given direction. In yet still other embodiments, the drive feature may be convex (FIG. 6) or concave (FIG. 7). Regardless of particular embodiment, the drive feature is configured to allow a load placed upon the support 10 to drive the body 24 into the intercoil space 26. More specifically, the drive feature 50 is configured to help avoid lateral input to the support 10, which tends to cause the support 10 to fall sideways while inserting the support 10 into the stator 16. This is similar to a screw being driven into wood when the drive force is heavy on the screw but the screw is not 100% aligned with the screwdriver. Most will recognize the irritation this creates when the tip of the screwdriver mars the work surface after the screw falls over. Similarly, when inserting the support 10 into the stator 16, if the support 10 falls over, damage can be done to the stator. And even if damage is not done, there is still time lost to reset the operation. Lost time is an expense that is to be avoided in all industrial operations. Feature 50 substantially reduces risk associated with insertion of the support 10 into the intercoil space 26. Finally it is noted that in some embodiments a stop 52 may be included to prevent overinsertion of support 10 in the stator 16.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ± 8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A support for a conductor in an electric machine, comprising:
a body configured and dimensioned to be receivable in a stator of the electric machine between adjacent coils, the body defining an axis;
a conductor anchor extending from the body at an angle to the axis, the conductor anchor having at least two conductor contact points, the angle of the anchor causing bending of the conductor at at least two of the at least two contact points when the conductor is disposed in the anchor and the body is disposed in the stator.

2. The support as claimed in claim 1, wherein the at least two contact points when viewed along a plane orthogonal to the axis of the body overlap one another.

3. The support as claimed in claim 1, wherein the anchor comprises an opening for the conductor.

4. The support as claimed in claim 3, wherein the opening for the conductor is perimetrically closed.

5. The support as claimed in claim 3, wherein the opening for the conductor is perimetrically open.

6. The support as claimed in claim 1, wherein the angle of the anchor is at 90 degrees +or- 15 degrees measured from the axis.

7. The support as claimed in claim 1, further including a drive feature.

8. The support as claimed in claim 7, wherein the drive feature is a flat arranged within 10 degrees of an orthogonal plane across the axis.

9. The support as claimed in claim 7, wherein the drive feature includes a convexity.

10. The support as claimed in claim 7, wherein the drive feature includes a concavity.

11. The support as claimed in claim 7, wherein the drive feature facilitates driving of the support along the axis without introduction of lateral momentum during driving.

12. The support as claimed in claim 1, wherein the body includes a barb feature configured and dimensioned to engage a coil.

13. The support as claimed in claim 1, wherein the conductor is a sensor conductor.

14. The support as claimed in claim 13, wherein the sensor is a thermistor.

15. A stator comprising:
a stator having a coil thereon;
a conductor separate from the coil; and
a support as claimed in claim 1 disposed in the stator and in supportive contact with the conductor.

16. A method for supporting a conductor at a stator of an electric machine, comprising:
disposing the support as claimed in claim 1 in contact with the conductor;
rotating the support to introduce plastic deformations in the conductor; and
inserting the body into the stator.

17. The method as claimed in claim 16, wherein the disposing includes adjusting a position of the support on the conductor prior to rotating the support to introduce the plastic deformations in the conductor.

18. The method as claimed in claim 17, wherein the adjusting includes ensuring that the conductor is prevented from sagging between support points.

19. The method as claimed in claim 16, wherein the disposing is by threading the conductor through a perimetrically closed anchor.

20. The method as claimed in claim 16, wherein the disposing is by sliding the conductor through a perimetrically open anchor.
